(19) United States
(12) Patent Application Publication
(10) Pub. No.: US 2009/0135545 A1
(43) Pub. Date: May 28, 2009

(54) CAPACITORS HAVING A HIGH ENERGY DENSITY

(75) Inventors: Florian Thomas, Ludwigshafen (DE); Patrick Deck, Mannheim (DE); Klaus Kuhling, Ellerstadt (DE); Hans-Josef Sterzel, Dannstadt-Schauernheim (DE); Daniel Fischer, Klettgau (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/718,035

(22) PCT Filed: Oct. 20, 2005
(86) PCT No.: PCT/EP05/11277

§ 371 Date: Apr. 26, 2007

(30) Foreign Application Priority Data
Oct. 26, 2004 (DE) 102004052086.0

(51) Int. Cl. H01G 4/008; H01G 4/06; B23P 17/00

(52) U.S. Cl. 361/305; 361/311; 29/25.42

(57) ABSTRACT

The invention relates to a capacitor having a porous electrically conductive substrate on whose inner and outer surfaces a first layer of a dielectric and an electrically conductive second layer are applied.

The invention also relates to a method for the production of such capacitors and to their use in electrical and electronic circuits.

The present invention relates to capacitors which have a porous electrically conductive substrate as the first electrode.

The storage of energy in a wide variety of applications is the subject of continuing development work. In particular, modules for the temporary storage of energy, in which very heavy currents and therefore high powers are incurred owing to short charging and discharge times, are very difficult to produce on the basis of batteries. Such modules could, for example, be employed in uninterruptible power supplies, buffer systems for wind power plants and in automobiles with hybrid propulsion.

In principle, capacitors are capable of being charged and discharged with very heavy currents. To date, however, capacitors which have a comparable energy density to Li ion batteries, i.e. approximately 250 Wh/l, are not known.

According to the capacitor formulae

E=½C·U² and C=∈·∈₀·A/d,

where: E=energy
C=capacitance
U=voltage
∈=dielectric constant of the dielectric
∈₀=permittivity of free space
A=electrode surface area
d=electrode spacing
   high energy densities can be achieved by using dielectrics with a high breakdown voltage and a high dielectric constant, as well as by large electrode surface areas and short electrode spacings.

So-called Ultracaps (double layer electrochemical capacitors) have very high capacitances owing to the use of extremely large electrode surface areas of up to 2,500 m²/g and very short electrode spacings but they only tolerate low voltages, about 2 V, and low temperatures owing to the organic electrolytes which they contain. In particular, the lack of thermal stability impedes their use in automobiles since they cannot be fitted in the engine compartment.

Tantalum capacitors consist of a sintered tantalum powder substrate. They therefore have very large electrode surface areas but, owing to their electrochemical production, they are restricted to tantalum pentoxide as a dielectric with only a low dielectric constant (∈=27) and to small dimensions. This prohibits their use in energy storage.

Multilayer ceramic capacitors (MLCCs) tolerate high voltages and ambient temperatures owing to the use of a ceramic dielectric. Ceramic dielectrics with high dielectric constants (>10,000) are furthermore available. However, the requirement for large electrode surface areas entails a large number of layers (>500). The production of such capacitors is therefore expensive and often prone to defects as the thickness of the layers increases. Likewise, it is not possible to produce capacitors with sizeable dimensions (i.e. volumes in the range of more than 1 cm³) since this would lead to stress cracks when fabricating the layer structure, and therefore to failure of the component.

### Examples of Specific Energy Densities:

Ultracap: Maxwell BCAP0010 (2600 F, 2.5 V, 490 cm³): 4.6 Wh/l
Tantalum: Epcos B45196H (680 μF, 10 V, 130 mm³): 0.073 Wh/l
MLCC: Murata GRM55DR73A104 KW01L (0.1 μF, 1000 V, 57 mm³): 0.25 Wh/l

DE-A-0221498 describes a high energy density ceramic capacitor which consists of an inert porous substrate, to which an electrically conductive first layer, a second layer of barium titanate and another electrically conductive layer are applied. To this end, an inert porous substrate of a material such as aluminum oxide is first coated with a metallization by vapor deposition or electroless plating. In a second step, the dielectric is produced by impregnation with a barium titanate nanodispersion and subsequent sintering at 900-1100° C.

Such a method can be problematic owing to the elaborate production method and the low thermal stability of the metallization. Production of the dielectric requires temperatures of 900-1100° C. Many metals already have a very high mobility at these temperatures, which together with the large surface tension of the metals can cause the metallization layer to coalesce and form fine droplets. This is observed in the case of a silver or copper metallization in particular. During impregnation with the barium titanate nanodispersion in the second step, nonuniform coating or clogging of the pores can furthermore take place if the dispersion contains sizeable particles or aggregates. In the event of nonuniform coating, it is not possible to use all of the internal surface of the porous substrate, which reduces the useful capacitance of the capacitor and greatly increases the risk of short circuits.

It is therefore an object of the invention to develop a capacitor which has a high energy density and a high thermal, mechanical and electrical load-bearing capacity, in order to allow it to be used in the aforementioned applications. The described production problems are also intended to be avoided.

The object is achieved in that the capacitor contains a porous, electrically conductive substrate, on as much as possible of whose inner and outer surfaces a dielectric and an electrically conductive layer are applied.

It has been found that porous substrates made of electrically conductive materials are also directly suitable as substrates. The use of electrically conductive substrate materials offers the advantage that additional coating of the substrate with a metallization is unnecessary owing to the pre-existing electrical conductivity of the substrate.

The invention therefore relates to capacitor which contains a porous electrically conductive substrate on whose inner and outer surfaces a first layer of a dielectric, which is not tantalum oxide or niobium oxide, and an electrically conductive second layer are applied.

The invention also relates to a method for the production of such capacitors, and to their use in electrical and electronic circuits.

Suitable substrates preferably have a specific surface (BET surface) of from 0.01 to 10 m²/g, particularly preferably from 0.1 to 5 m²/g.

Such substrates may, for example, be produced from powders having specific surfaces (BET surface) of from 0.01 to 10 m²/g by compression or hot compression at pressures of from 1 to 100 kbar and/or sintering at temperatures of from 500 to 1500° C., preferably from 700 to 1300° C. The compression or sintering is preferably carried out in an atmosphere consisting of air, inert gas (for example argon or nitrogen) or hydrogen, or mixtures of these, with an atmosphere pressure of from 0.001 to 10 bar.

The pressure used for the compression and/or the temperature used for the heat treatment depend on the materials being used and on the intended material density. A density of from 30 to 70% of the theoretical value is preferably desired in order to ensure sufficient mechanical stability of the capacitor for the intended purpose, together with a sufficient pore fraction for subsequent coating with the dielectric.

It is possible to use powders of all metals or alloys of metals which have a sufficiently high melting point of at least 900° C., preferably more than 1200° C., and which do not enter into any reactions with the ceramic dielectric during the subsequent processing.

The substrates preferably contain at least one metal, preferably Ni, Cu, Pd, Ag, Cr, Mo, W, Mn or Co and/or at least one metal alloy based on these.

Preferably, the substrate consists entirely of electrically conductive materials.

According to another preferred variant, the substrate consists of at least one nonmetallic material in powder form, which is encapsulated by at least one metal or at least one metal alloy as described above. The nonmetallic material is preferably encapsulated so that no reactions that deteriorate the properties of the capacitor take place between the nonmetallic material and the dielectric.

Such nonmetallic materials may, for example, be Al₂O₃ or graphite. Nevertheless, SiO₂, TiO₂, ZrO₂, SiC, Si₃N₄ or BN are also suitable. All materials which, owing to their thermal stability, avoid further reduction of the pore fraction due to sintering of the metallic material during heat treatment of the dielectric are suitable.

The substrates used according to the invention may have a wide variety of geometries, for example cuboids, plates or cylinders. Such substrates can be produced in various dimensions, preferably of from a few mm to a few dm, and can therefore be perfectly matched to the relevant application. In particular, the dimensions can be tailored to the required capacitance of the capacitor. For energy storage applications in wind power plants or hybrid vehicles, for example, capacitors with a high capacitance and large dimensions in the range of from 5 cm to 5 dm may be used, while applications in microelectronics require small capacitors of low capacitance with dimensions in the range of from 1 mm to 5 cm.

The substrates are connected to a contact. Contact may preferably made by introducing an electrically conductive wire or strip directly during the aforementioned production of the substrate. As an alternative, contact may also be made by forming an electrically conductive connection between an electrically conductive wire or strip and a surface of the substrate, for example by soldering or welding.

The porous electrically conductive substrates employed according to the invention are used as the first electrode and at the same time as a substrate for the dielectric.

All materials conventionally usable as dielectrics may be employed. Tantalum oxide and niobium oxide are excluded according to the invention.

The dielectrics used should have a dielectric constant of more than 100, preferably more than 500.

The dielectric preferably contains oxide ceramics, preferably of the perovskite type, with a composition that can be characterized by the general formula AₓB_{y}O₃. Here, A and B denote monovalent to hexavalent cations or mixtures of these, preferably Mg, Ca, Sr, Ba, Y, La, Ti, Zr, V, Nb, Ta, Mo, W, Mn, Zn, Pb or Bi, x denotes number of from 0.9 to 1.1 and y denotes number of from 0.9 to 1.1. A and B in this case differ from each other.

It is particularly preferable to use BaTiO₃. Other examples of suitable dielectrics are SrTiO₃, (Ba₁₋ₓSrₓ)TiO₃ and Pb(ZrₓTi₁₋ₓ)O₃, where x denotes number of between 0.01 and 0.99.

In order to improve specific properties such as the dielectric constant, resistivity, breakdown strength or long-term stability, the dielectric may also contain dopant elements in the form of their oxides, in concentrations advantageously of between 0.01 and 10 atomic %, preferably from 0.05 to 2 atomic %. Examples of suitable dopant elements are elements of the 2^{nd} main group, in particular Mg and Ca, and of the 4^{th} and 5^{th} periods of the subgroups, for example Sc, Y, Ti, Zr, V, Nb, Cr, Mo, W, Mn, Fe, Co, Ni, Cu, Ag and Zn, of the periodic table, as well as the lanthanides such as La, Ce, Pr, Nd, Sm, Eu, Gd, Tb, Dy, Ho, Er, Tm, Yb and Lu.

The dielectric may be deposited on the porous substrates from solutions (so-called solgel method). The provision of a homogeneous solution is particularly advantageous compared with the use of a dispersion, so that clogging of pores and nonuniform coating cannot occur even in the case of sizeable substrates. To this end, the porous substrates are impregnated with solutions that can be produced by dissolving the corresponding elements or their salts in solvents.

Salts which may preferably be used are oxides, hydroxides, carbonates, halides, acetylacetonates or derivatives of these, salts of inorganic acids having the general formula M(R—COO)ₓ with R═H, methyl, ethyl, propyl, butyl or 2-ethylhexyl and x=1, 2, 3, 4, 5 or 6, salts of alcohols having the general formula M(R—O)ₓ with R=methyl, ethyl, propyl, isopropyl, butyl, sec-butyl, isobutyl, tert-butyl, 2-ethylhexyl, 2-hydroxyethyl, 2-methoxyethyl, 2-ethoxyethyl, 2-butoxyethyl, 2-hydroxypropyl or 2-methoxypropyl and x=1, 2, 3, 4, 5 or 6, of the aforementioned elements (here denoted as M) or mixtures of these salts.

Solvents which may preferably be used are carboxylic acids having the general formula R—COOH with R═H, methyl, ethyl, propyl, butyl or 2-ethylhexyl, alcohols having the general formula R—OH with R=methyl, ethyl, propyl, isopropyl, butyl, sec-butyl, isobutyl, tert-butyl or 2-ethylhexyl, glycol derivates having the general formula R¹—O—(C₂H₄—O)ₓ—R² with R¹ and R²═H, methyl, ethyl or butyl and x=1, 2, 3 or 4, 1,3-dicarbonyl compounds such as acetyl acetone or acetyl acetonate, aliphatic or aromatic hydrocarbons, for example pentane, hexane, heptane, benzene, toluene or xylene, ethers such as diethyl ether, dibutyl ether or tetrahydrofuran, or mixtures of these solvents.

The impregnation of the substrates may, or for example, be carried out using low-viscosity solutions by immersing the substrates in the solution, or using higher-viscosity solutions by pressure impregnation or by flow through the substrates. The solution may also be applied by spraying. In this case, it is necessary to ensure complete wetting of the inner and outer surfaces of the substrates.

The solution is subsequently calcined to form the corresponding ceramic in an oven at a temperature of from 500 to 1500° C., preferably from 700 to 1200° C., and sintered to form a film. Inert gases (for example argon, nitrogen), hydrogen, oxygen or steam, or mixtures of these gases, may be used as the atmosphere with an atmosphere pressure of from 0.001 to 10 bar. In this way, thin films with a thickness of preferably from 10 to 1000 nm, particularly preferably from and 50 to 500 nm, are obtained over the entire inner and outer surfaces of the porous substrates. As far as possible, the entire inner and outer surfaces should be covered in order to ensure a maximum capacitance of the capacitor.

The film thickness of the applied dielectric can be adjusted through the concentration of the coating solution or by repetition of the coating. In the case of multiple coating, according to experience it is sufficient to calcine at a temperature of from 200 to 600° C. after each coating step, preferably at temperatures of about 400° C., and only to carry out the subsequent sintering at higher temperatures of from 500 to 1500° C., preferably from 700 to 1200° C. In order to improve the electrical properties of the dielectric, it may be necessary to carry out another heat treatment after the sintering, at a temperature of between 200 and 600° C. in an atmosphere having an oxygen content of from 0.01% 25%.

According to another preferred variant of the method, the dielectric is applied to the substrate by means of a technique which is described in the literature as “templateassisted wetting” (see, for example, Y. Luo, I. Szafraniak, V. Nagarjan, R. B. Wehrspohn, M. Steinhart, J. H. Wendorff, N. D. Zakharov, R. Ramesh, M. Alexe, Applied Physics Letters 2003, 83, 440). To this end, the substrate is brought in contact with a solution of a polymeric precursor of the dielectric, so that a film of the solution is formed over the entire inner and outer surfaces of the substrate. The solution is subsequently converted into the ceramic dielectric by heat treatment, similarly as in the method described above.

According to the invention, an electrically conductive second layer is applied as a reference electrode on the dielectric. It may be any electrically conductive material conventionally used for this purpose according to the prior art. For example, manganese dioxide or electrically conductive polymers such as polythiophenes, polypyrroles, polyanilines or derivatives of these polymers are used. A better electrical conductivity and therefore lower equivalent series resistance (ESR) of the capacitor is obtained by applying metal layers as the reference electrode, for example layers of copper according to the as yet unpublished Patent Application DE 10325243.6.

The external contact with the reference electrode may also the made by any technique conventionally used for this purpose according to the prior art. For example, the contact may be made by graphitizing, applying conductive silver and/or soldering. Once it has been provided with contacts, the capacitor may then be encapsulated in order to protect it against external effects.

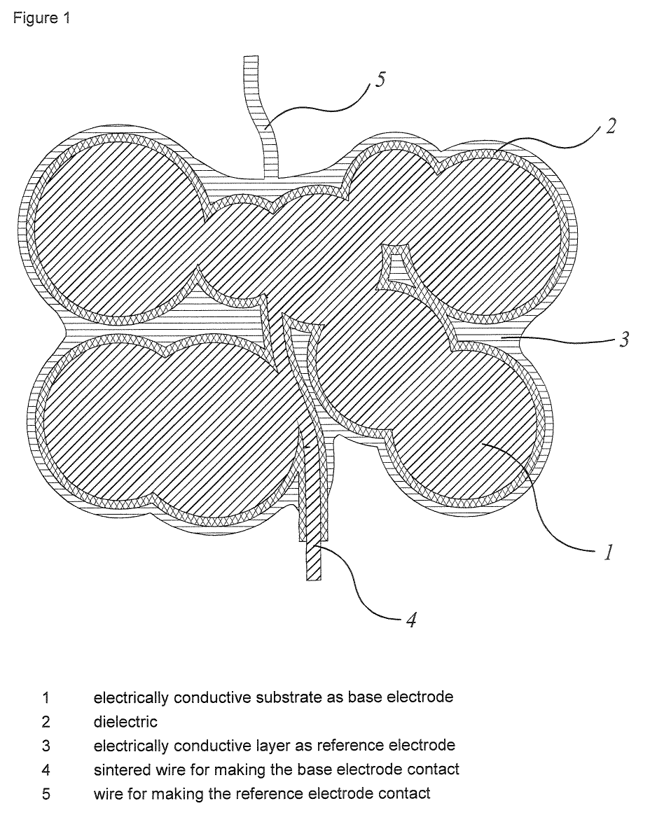

The capacitors produced according to the invention have a porous electrically conductive substrate, on virtually all of whose inner and outer surfaces a layer of a dielectric and an electrically conductive layer are applied. The diagram of such a capacitor is represented by way of example in FIG. 1.

The capacitors produced according to the invention have a high energy density together with a high thermal, mechanical and electrical load-bearing capacity, and they are therefore suitable for the storage of energy in a wide variety of applications, especially in those which require a high energy density. Compared with the conventional tantalum capacitors or multilayer ceramic capacitors, their production method allows simple and economical production of capacitors having significantly larger dimensions and a correspondingly high capacitance.

Such capacitors may, for example, be used as a smoothing or storage capacitor in electrical energy technology, as a coupling, filter or small storage capacitor in microelectronics, as a substitute for secondary batteries, as primary energy storage units for mobile electrical devices, for example electrical power tools, telecommunication applications, portable computers, medical devices, for uninterruptible power supplies, for electrical vehicles, as complementary energy storage units for electrical vehicles or hybrid vehicles (“recuperative brakes”), for electrical elevators, and as buffer energy storage units to compensate for power fluctuations of wind, solar, solar thermal or other power plants.

The invention will be explained in more detail with reference to the following exemplary embodiments, but without thereby implying any limitation.

### EXAMPLES

### Example 1

A cylindrical quartz grass crucible was filled with a nickel wire and nickel powder (particle size D50=6.6 μm) and mechanically condensed uniformly. This was subsequently sintered for 3 h at 800° C. in a hydrogen atmosphere. A solid substrate with a pore volume fraction of approximately 40% and a BET surface of 0.1 m²/g was obtained.

### Example 2

50.0 g of a 60% strength (w/w) solution of barium bis-2-methoxyethoxide in methoxyethanol were stirred with 36.4 g of titanium tetrakis-2-methoxyethoxide for 30 min at room temperature and 28 g of a 25% strength solution (w/w) of water in methoxyethanol were subsequently added dropwise. A solution with a content of 20% was obtained (w/w with respect to BaTiO₃). The concentration of the solution could be increased by evaporating methoxyethanol to 40% (w/w with respect to BaTiO₃).

### Example 3

51.0 g of barium acetate were dissolved in 70 g of boiling glacial acetic acid. 68.0 g of titanium tetra-n-butylate were then added at 70° C. A solution with a content of 25% was obtained (w/w with respect to BaTiO₃).

### Example 4

A solution of 48.0 g titanium tetrakis-2-ethylhexanolate in 50 g of methoxyethanol were added to 40.0 g of a 60% strength (w/w) solution of barium bis-2-methoxyethoxid in methoxyethanol. This was stirred for 12 h and methoxyethanol was subsequently removed under a reduced pressure. A solution with a content of 22% was obtained (w/w with respect to BaTiO₃).

### Example 5

A substrate according to Example 1 was immersed in a solution according to Example 2. Bubbling could no longer be seen after a few minutes. A vacuum may be applied in order to facilitate full impregnation. The substrate completely filled with solution was removed from the solution, and any solution adhering to the outside was dripped off.

### Example 6

A substrate according to Example 1 was fitted in a holding device by using a seal, and flushed with a solution according to Example 3 or 4 at a pressure of 4 bar until bubbling could no longer be seen. The substrate completely filled with solution was removed from the solution, and any solution adhering to the outside was dripped off.

### Example 7

An impregnated substrate according to Example 5 or 6 was treated for 3 h in an oven at a temperature of 400° C. in an inert gas atmosphere saturated with water vapor, in order to calcine the solution to form a ceramic coating. The sequence of impregnation/calcining was carried out five times, then the ceramic coating was sintered for 6 h at 80° C. in an inert gas atmosphere with an oxygen content of 1 ppm.

### Example 8

A ceramic-coated substrate according to Example 7 was immersed in a saturated solution of manganese(II) nitrate in water until bubbling could no longer be seen. The substrate completely filled with solution was removed from the solution, and any solution adhering to the outside was dripped off. The impregnated substrate was then treated for 3 h in an oven at a temperature of 300° C. in air, in order to calcine the solution to form an electrically conductive layer of manganese dioxide. The sequence of impregnation/calcining was carried out until a constant weight was achieved, and all the pores were completely filled with manganese dioxide.

### Example 9

A ceramic-coated substrate according to Example 7 was fitted in a holding device by using a seal, and flushed at a pressure of 4 bar with a solution of copper(II) formate in a 1:1 mixture of methoxyethylamine and methoxypropylamine (content 10% w/w with respect to Cu) according to the as yet unpublished Patent Application DE 10325243.6, until bubbling could no longer be seen. The substrate completely filled with solution was removed from the solution, and any solution adhering to the outside was dripped off. The impregnated substrate was then treated for 2 h in an oven at a temperature of 220° C. in an inert gas atmosphere (Ar or N₂), in order to produce a copper coating. The sequence of impregnation/heat treatment was carried out several times in order to achieve complete coating with an electrically conductive film.

1-16. (canceled)

17. A capacitor which comprises a porous electrically conductive substrate on whose inner and outer surfaces a first layer of a dielectric, which is not tantalum oxide or niobium oxide, and an electrically conductive second layer are applied and wherein the substrate is produced from
a₁) at least one nonmetallic material in a powder form, which is encapsulated by at least one metal or at least one metal alloy, or
a₂) electrically conductive materials in a powder form.

18. The capacitor according to claim 17, wherein the substrate has a specific surface of from 0.01 to 10 m²/g.

19. The capacitor according to claim 17, wherein the substrate comprises at least one metal or at least one metal alloy, which has a melting point of at least 900° C.

20. The capacitor according to claim 17, wherein the substrate comprises Ni, Cu, Pd, Ag, Cr, Mo, W, Mn or Co and/or at least one metal alloy based on these.

21. The capacitor according to claim 17, wherein the substrate is produced from electrically conductive materials in powder form.

22. The capacitor according to claim 17, wherein the substrate is produced from metals in a powder form.

23. The capacitor according to claim 17, wherein the substrate is produced from at least one nonmetallic material in a powder form, which is encapsulated by at least one metal or at least one metal alloy.

24. The capacitor according to claim 17, wherein the nonmetallic material is Al₂O₃ or graphite.

25. The capacitor according to claim 17, wherein the dielectric has a dielectric constant of more than 100.

26. The capacitor according to claim 17, wherein the dielectric comprises an oxide ceramic of the perovskite type with the composition AₓB_{y}O₃, where A and B denote monovalent to hexavalent cations or mixtures of these, x denotes number of from 0.9 to 1.1 and y denotes number of from 0.9 to 1.1.

27. The capacitor according to claim 17, wherein the dielectric comprises BaTiO₃.

28. The capacitor according to claim 17, wherein the dielectric comprises one or more dopant elements in the form of their oxides, in concentrations of between 0.01 and 10 atomic %.

29. A method for producing capacitors, wherein a first layer of a dielectric, which is not tantalum oxide or niobium oxide, and a second layer of an electrically conductive material, which is provided with a contact, are applied to the inner and outer surfaces of a porous electrically conductive substrate which is pro-vided with a contact.

30. The method according to claim 29, wherein the porous substrates are produced from powders having specific surfaces of from 0.01 to 10 m²/g by compression or hot compression at pressures of from 1 to 100 kbar and/or sintering at temperatures of from 500 to 1500° C.

31. The method according to claim 29, wherein the dielectric is deposited on the porous substrates from a solution.

32. The method according to claim 29, wherein the porous substrates are impregnated with a solution which comprises precursor compounds of the dielectric in a dissolved form, and are subsequently heat treated.

33. The method according to claim 29, wherein dielectric films with a thickness of from 10 to 1000 nm are obtained over the entire inner and outer surfaces of the porous substrates.

34. The method according to claim 29, wherein dielectric films with a thickness of from 50 to 500 nm are obtained over the entire inner and outer surfaces of the porous substrates.
